(19) United States
(12) Patent Application Publication
(10) Pub. No.: US 2013/0245517 A1
(43) Pub. Date: Sep. 19, 2013

(54) EDEMA DRAINAGE SEAT CUSHION

(71) Applicant: Nola Ann Eddy, Wethersfield, CT (US)

(72) Inventor: Nola Ann Eddy, Wethersfield, CT (US)

(21) Appl. No.: 13/423,512

(22) Filed: Mar. 19, 2012

(51) Int. Cl. A61H 7/00; A47C 7/02; A47C 16/00

(52) U.S. Cl. 601/136; 267/142

(57) ABSTRACT

An apparatus and method of improving the efficiency of lymphatic and venous circulation of the lower body using a seat cushion composed of breathable open celled polyurethane fabric with strips of dense foam to provide compression with constant shear force to interstitial tissue. The strips of dense foam apply a shear force onto the interstitial tissue, which positively affects the thixotropic properties of the interstitial fluid in the congested fibrotic tissue and thereby decreases the viscosity of the interstitial fluid over time. The strips of the dense foam are designed in such a pattern that channels interstitial fluid away from the dorsolateral and dorsomedial lymphatic territory of the thigh to the lymphatic capillary network on the lateral border of the thigh and lower lymph quadrant of the trunk.

### TECHNICAL FIELD

The present invention is generally directed to a seat cushion. More particularly, the present invention is directed to a medical seat cushion for the purposes of reducing interstitial fluid and congested fibrotic tissue in persons with edema in the lower regions, e.g. thighs, knees, and buttocks.

### BACKGROUND OF THE INVENTION

Chronic leg edema is often suffered by people who have medical conditions such as lymphedema, venous stasis, wounds, obesity, paresis and lipoedema. People with chronic leg edema struggle with functional mobility due to the weight of the leg, weakness of the muscles, and dependency to the sitting position throughout the day and night. When the body is sitting for most of the day, venous and lymphatic flow in the leg becomes sluggish and interstitial tissue becomes congested. A fibrotic ridge of tissue often forms on the posterior aspect of the distal thigh and behind the knee which may be accompanied by fibrotic and edematous lobules.

Further, individuals struggling with obesity often have a pannus consisting of a dense layer of fatty tissue in the lower abdominal area which constricts lymph flow through the inguinal lymph bed. In the seated position, the pannus compromises fibrosis resolution and fluid exchange through the inguinal lymph bed and deeper lymphatic trunks in the pelvis. The anatomical alternative of lymphatic fluid drainage in the obese and sedentary individual would be to the outer thighs, buttocks, and up to the lymph watershed of the waist. However, this pathway is also compromised for the individual in the seated position by the external pressures on the posterior and lateral pelvic fatty tissue and chair. The combination of congested tissue in the thigh, the fibrotic ridge on the posterior thigh, and lack of muscle movement creates unhealthy fluid exchange and furthers the pathology of the lower leg, including venous stasis, edema, lymphedema and wounds.

Contemporary designs of seat cushions are often aesthetic, supportive, and pressure relieving. Medical seating designs focus on relieving pressure from the spine, coccyx, skin, and boney prominences in the hips. The construction of medical cushions used to address lymph flow through the thigh and buttocks are not evident. Medical cushions provide support and decompression through constant force on the legs, but do not address fibrotic tissue reduction or directional fluid exchange. The distal aspect of current medical and non-medical seat cushions end under the thigh and knee. The ends of these cushions create an abrupt impression on the posterior thigh, most noted with individuals who rely on the seated position throughout the day. In many cases, this abrupt impression compromises circulation of the leg and creates a ridge of fibrotic tissue at the back of the thigh and knee. In advanced cases, this fibrotic ridge extends to the inner and outer aspects of the knee and thigh in the form of lobules. This fibrotic tissue decreases the effectiveness of an already compromised circulation and contributes to further pathology of the leg.

From the above, it is therefore seen that there exists a need in the art to overcome the deficiencies and limitations described herein and above.

### SUMMARY OF THE INVENTION

The shortcomings of the prior art are overcome and additional advantages are provided through a seat cushion designed to compress and stretch interstitial tissue, reduce fibrotic tissue by means of thixotropic influence, and stimulate lymph vessel clearing by channeling interstitial fluid along the lymphatic pathways on the posterior and lateral aspect of the thigh and buttocks.

Lymphatic vessels, specifically the deeper lymphangions, rely on physical movement of the body to stimulate the smooth muscle layer on the surface of the vessel. Accordingly, it is an object of the invention to provide two-way stretching foam strips to stimulate the smooth muscle contraction of the lymphangions, thus forcing the contraction and clearing of these vessels in the direction of the lymphatic pathway, thereby creating an efficient exchange of interstitial fluid from the thighs to the trunk.

Applying varying pressure against the surface of the leg influences the thixotropic properties of fibrotic tissue. Interstitial fibrotic tissue becomes less viscous when subjected to a constant shear rate. Accordingly, it is another object of the present invention to reduce the viscosity of fibrotic interstitial fluid through the use of alternating surface pressures against the surface of the leg and buttocks.

A sedentary person may also have an abdominal pannus which compresses the inguinal lymph bed of the thigh. The healthy lymph pathway of the leg is from the foot to the inguinal lymph node bed with several vessels directed to the posterior and lateral thigh. Therefore, it is yet another object of the present invention to enhance interstitial fluid resorption of the leg by assisting the inguinal lymph bed, as well as reroute interstitial fluid away from the inguinal lymph bed when constricted and channel fluid flow to the posterior and lateral thigh and buttocks.

Lastly, but not limited hereto, it is an even further object of the present invention to incorporate a posterior knee extension pad to apply gentle pressure against the tissue where the seating surface ends, thereby reducing the formation of a fibrotic ridge on the posterior thigh.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a top elevation view of the seat cushion;

FIG. 2 is a top elevation view of the seat cushion depicting the foam strips;

FIG. 2b is an isometric detail view illustrating the elements of the seat cushion;

FIG. 3 is a partially isometric and cross-sectional front view of the seat cushion illustrating the top and bottom covers enclosing the foam strips;

FIG. 4 is a partially isometric and cross-sectional side view of the seat cushion illustrating the top and bottom covers enclosing the foam strips;

FIG. 5a is a partially isometric and cross-sectional side view of the seat cushion in use with the posterior knee extension pad; and

FIG. 5b is a partially isometric and cross-sectional side view of the posterior knee extension pad.

### DETAILED DESCRIPTION

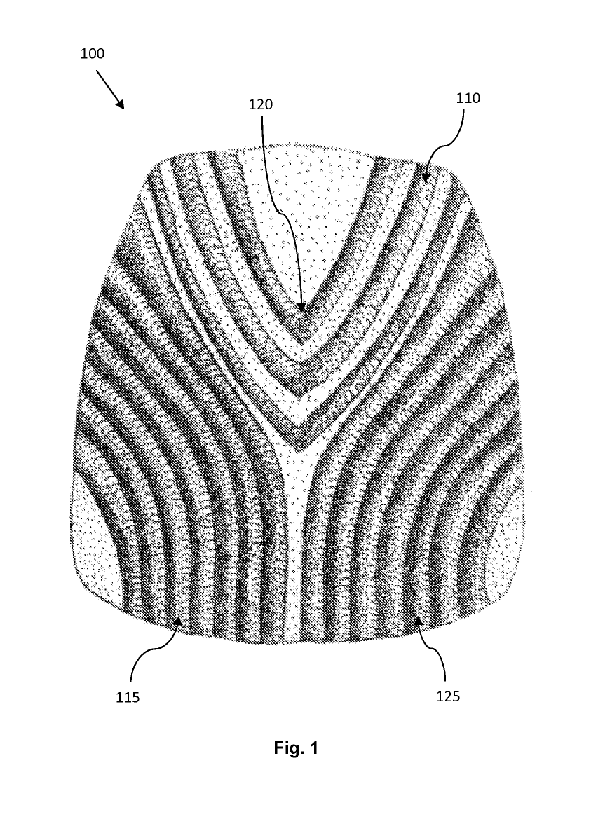

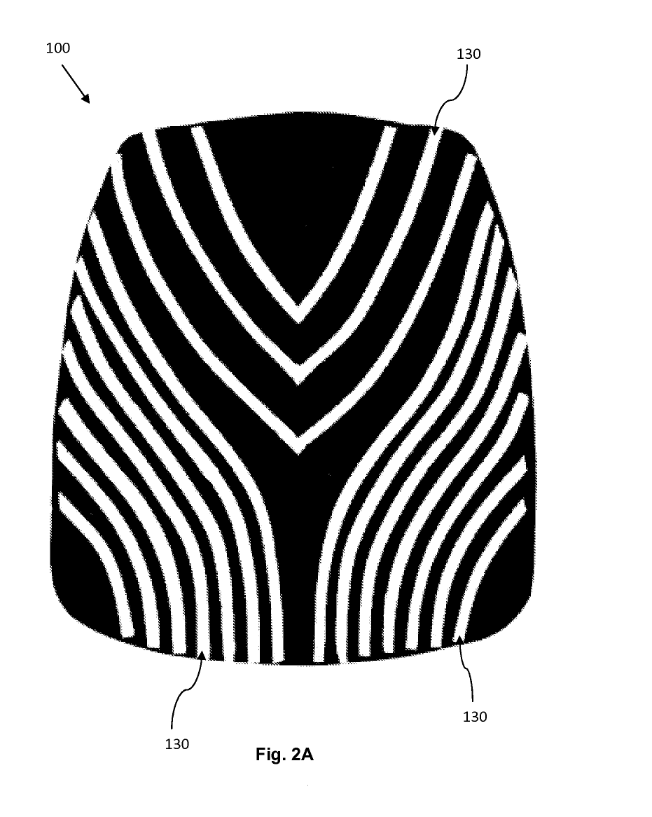

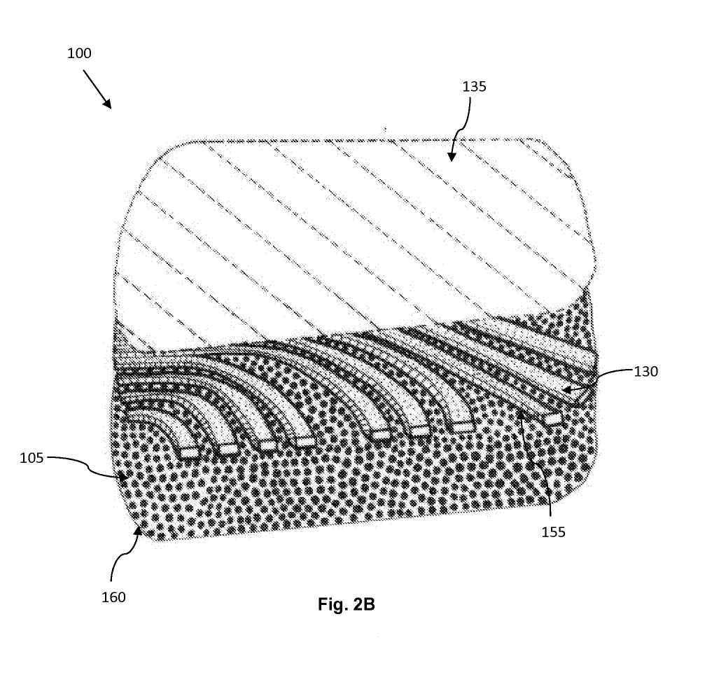

FIGS. 1 through 4 depict the seat cushion 100 in its preferred embodiment. As it came be seen in FIG. 1 and FIG. 2a, the seat cushion 100 comprises two distinct foam strip portions. The first portion 115, 125 comprises substantially straight lines of foam strips 130, while the foam strips 130 of the second portion 110 diverge from a centerpoint, such as centerpoint 120, to substantially form a chevron pattern. The design pattern of the foam strips 130, are positioned to channel interstitial fluid away from the dorsolateral and dorsomedial territory of the thigh to the lymphatic capillary network on the lateral border of the thigh and lower lymph quadrant of the trunk.

FIGS. 2b, 3, and 4 further illustrate the preferred elemental embodiments of the seat cushion 100. As shown in the detailed view of FIG. 2b, a top cover 135 and a bottom cover 105 encapsulate the foam strips 130. The foam strips 130 are preferably fabricated of a latex free material. The top cover 135 and bottom cover 105 are fabricated preferably of a breathable open celled polyurethane fabric. For reasons of safety, the foam strips 130, top cover 135, and bottom cover 105 are fabricated preferably with a fire retardant compound.

As shown in FIG. 2b, foam strip stitching 155 is placed around the perimeter of each individual foam strip 130, and joins the bottom cover 105 to the top cover 135. This foam strip stitching 155 helps each individual foam strip 130 maintain its respective position as part of the patterns defined by the first portion 115, 125 and second portion 110.

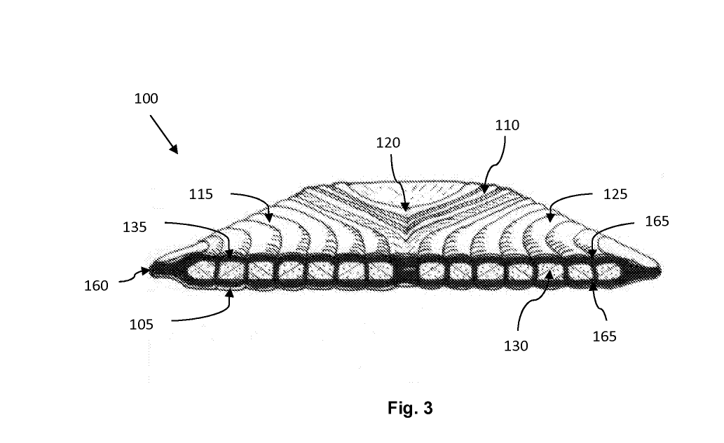

As further illustrated in the cross-sectional view of FIG. 3, perimeter stitching 160 is placed around the outer edge of the seat cushion 100 to fasten the bottom cover 105 to the top cover 135. Further channel stitching 165 is placed on each side of the foam strips 130. Channel stitching 165 penetrates both the bottom cover 105 and top cover 135 to further secure respective covers to each other and creates individual channel pockets for each individual foam strip 130.

The cross-sectional view of FIG. 3 further illustrates that the preferred embodiment of seat cushion 100 comprises the foam strips 130 substantially spanning across the entire width of the seat cushion 100. It can also be seen that the first portion 115, 125 and second portion 110 are substantially mirrored about a centerline through centerpoint 120, which also divides seat cushion's 100 width into substantially equal halves. In this preferred embodiment, the foam strip 130 in the first portion 115, 125 is placed approximately 1.0 inch on center, while the first foam strip 130 in the second portion 110 is secured on a diagonal approximately 1.5 inches apart. Each foam strip 130 has an average width, in cross-section, approximately 0.5 inches and an average height, in cross-section, approximately 0.25 inches.

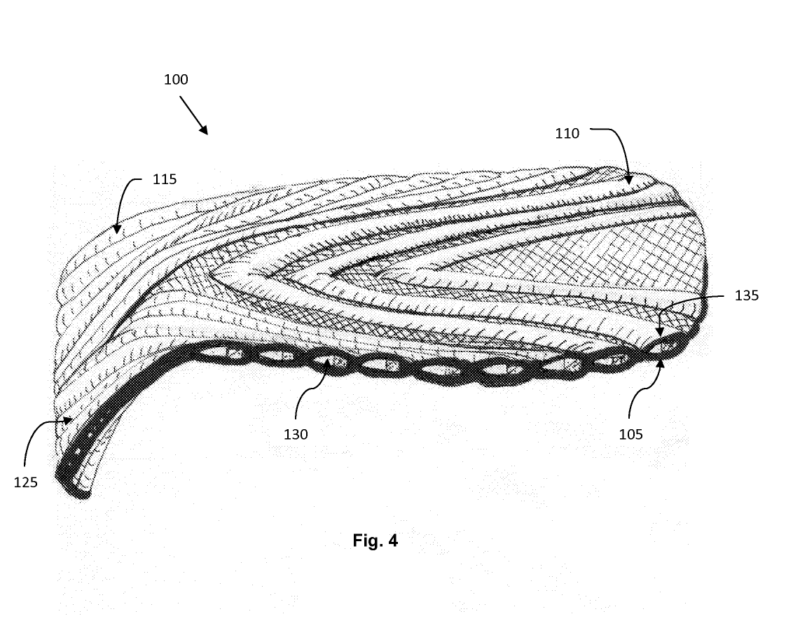

In accordance with the preferred embodiment, FIG. 4 illustrates that in use, the front edge of the seat cushion 100 extends down the front edge of the seat surface. It has been found that this embodiment aids in reducing the fibrotic ridge formed behind a person's lower thigh and knee region, which is created by prolonged exposure to the pressure of a seat surface's front edge.

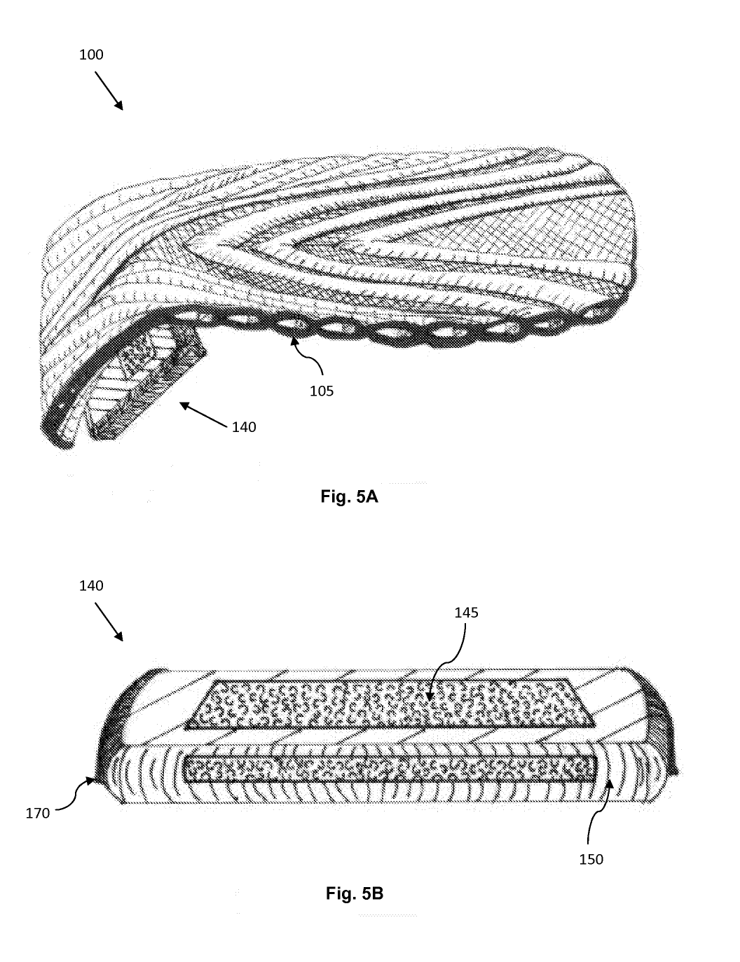

As further shown in FIG. 5a, an alternative embodiment to the seat cushion 100 incorporates a posterior knee extension pad 140. In this manner, the seat cushion 100 provides the maximum reduction to the fibrotic ridge and maximum resistance to the creation of the fibrotic ridge formed behind a person's lower thigh and knee region by applying gentle pressure against the tissue where the seat surface ends. The knee extension pad 140 is placed between the seat surface and the front edge of the bottom cover 105 behind a person's knee. The knee extension pad 140 extends the entire width of the seat cushion 100, and as shown in FIG. 5b, comprises dense foam 145 enclosed by a covering fabric 150. The covering fabric 150 secures the dense foam 145 via knee extension pad stitching 170 located around the perimeter of the knee extension pad 140. The dense foam 145 comprises material properties that are substantially of the same foam used for the foam strips 130, while the covering fabric 150 comprises substantially of the same breathable open celled polyurethane fabric used for the top cover 135 and bottom cover 105.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

1. A pad comprising:
a top and bottom cover disposed substantially in at least one plane, said covers being oppositely disposed,
said covers containing there between a plurality of substantially parallel strips of a compressible material forming spaced apart ridges,
said plurality of elongated strips having a first portion in which said strips are disposed in substantially straight lines and a second portion in which said strips are angled distally away from a centerline.

2. The pad of claim 1, wherein said pad is a seat cushion.

3. The pad of claim 2, wherein said seat cushion further includes an additional compressible member affixed to one of said covers, said member being positionable behind at least one knee of a human body sitting on said pad.

4. The pad of claim 1, wherein said top and bottom covers comprise a breathable open celled polyurethane fabric.

5. The pad of claim 1, wherein said compressible material comprises a dense foam.

6. The pad of claim 1, wherein said second portion of said elongated strips is substantially positioned in a chevron pattern.

7. The pad of claim 1, wherein said elongated strips in said first portion are positioned substantially radial from a center point.

8. The pad of claim 1, wherein said elongated strips of compressible material are substantially the same height within said pad.

9. The pad of claim 1, wherein said elongated strips of compressible material are substantially the same width within said pad.

10. The pad of claim 1, wherein said elongated strips of compressible material have substantially the same density throughout entire said pad.

11. The pad of claim 1, wherein said first and second portions are approximately the same size.

12. A seat cushion for treating the presence of high levels of interstitial fluids in a human body, said cushion comprising:
a plurality of channels defined by strips of compressible material configured so that a human body seated thereon experiences a flow of said interstitial fluids away from areas of their concentration.

13. The seat cushion of claim 12, wherein said seat cushion further comprises an additional compressible member affixed to thereon, said member being positionable behind at least one knee of said human body sitting on said seat cushion.

14. The seat cushion of claim 13, wherein said additional compressible member comprises a dense foam enclosed by a breathable open cell polyurethane fabric.

15. The seat cushion of claim 13, wherein said additional compressible member extends the entire width of said seat cushion.

16. A method of reducing high levels of interstitial fluid in a human body by applying a shearing force to the sub-dermal fibrotic interstitial tissue comprising:
placing a pad with a front end and a back end on a sitting surface,
positioning said human body in a seated position on said pad,
said pad comprising an open celled polyurethane fabric cover containing elongated strips of a dense foam that increase pressure and apply a shearing force against said sub-dermal fibrotic interstitial tissue to create a thixotrophic effect to increase the absorption rate of said interstitial fluid into said human body.

17. The method of claim 16, further comprising placing said front end of said pad over an edge of said sitting surface and placing said back end onto said sitting surface, thereby placing said pad onto two planes.

18. The method of claim 16, further comprising placing an additional compressible member affixed to said pad's front end and underneath at least one knee of said human body.

19. A seat cushion having disposed therein a plurality of channels defined by strips of compressible material configured so that a human body seated thereon experiences a flow of interstitial fluids away from areas of their concentration.
